(19) United States
(12) Patent Application Publication
(10) Pub. No.: US 2025/0110891 A1
(43) Pub. Date: Apr. 3, 2025

(54) DEMAND-ADAPTIVE MEMORY COMPRESSION IN HARDWARE

(71) Applicant: VIRGINIA TECH INTELLECTUAL PROPERTIES, INC., Blacksburg, VA (US)

(72) Inventor: Xun Jian, Christiansburg, VA (US)

(21) Appl. No.: 18/901,218

(22) Filed: Sep. 30, 2024

Related U.S. Application Data
(60) Provisional application No. 63/586,833, filed on Sep. 29, 2023.

(51) Int. Cl. G06F 12/10

(52) U.S. Cl. CPC G06F 12/10

(57) ABSTRACT

Various aspects of a computing system for dynamically managing storage of data in a memory are described. In one example, a computing system includes a memory having a plurality of memory levels and a processing circuit configured to dynamically manage storage of data in the memory based on instructions received from an operating system (OS). To dynamically manage storage of the data, the processing circuit is further configured to determine a first memory level and a second memory level, where the first memory level is used to store uncompressed pages and the second memory level is used to store compressed pages. The processing circuit is further configured to determine a free list of free pages in the first memory level or the second memory level and store a page associated with the data in the first level or the second level based at least in part on the free list.

### CROSS-REFERENCE TO RELATED APPLICATION

This application claims the benefit of and priority to U.S. Provisional Patent Application No. 63/586,833, filed Sep. 29, 2023, entitled “DEMAND-ADAPTIVE MEMORY COMPRESSION IN HARDWARE,” the content of which is hereby incorporated herein by reference in its entirety.

### STATEMENT REGARDING FEDERALLY SPONSORED RESEARCH OR DEVELOPMENT

This invention was made with government support under grant numbers 1942590 and 1919113, awarded by the National Science Foundation (NSF). The government has certain rights in the invention.

### BACKGROUND

Computer memory has undergone transformations over the years, evolving from relatively simple and expensive components to complex and costly resources, especially in the context of today's data-intensive applications. Today, many applications in the fields of video editing, gaming, machine learning, and big data, among others, require large amounts of memory. Different types of memories can include dynamic random-access memory (DRAM), static random-access memory (SRAM), and non-volatile memory (NVM), to name a few. High-performance computing in the fields like artificial intelligence (AI), scientific research, simulation, and high-performance computing systems may require vast amounts of DRAM to handle the huge datasets they process.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts an example computing system for dynamically managing storage of data in memory according to various embodiments of the present disclosure.

FIG. 2 depicts a free list in a first memory level (ML) for use in one or more computing systems according to various embodiments of the present disclosure.

FIG. 3 depicts a free list in a second memory level (ML) for use in one or more computing systems according to various embodiments of the present disclosure.

FIG. 4 depicts a hardware-compressed page table block (PTB) encoding for use with one or more computing systems according to various embodiments of the present disclosure.

FIG. 5 depicts a timeline of various functions executable by one or more processing circuitries according to various embodiments of the present disclosure.

FIG. 6 depicts a compression translation entry (CTE) buffer that can be used by one or more computing systems according to various embodiments of the present disclosure.

FIG. 7 depicts a computing system for obtaining embedded CTEs to access data in a memory according to various embodiments of the present disclosure.

FIG. 8 depicts a series of flowcharts that can be executed by one or more computing systems according to various embodiments of the present disclosure.

FIG. 9 depicts an internal layout of a CTE for one or more computing systems according to various embodiments of the present disclosure.

FIG. 10 depicts a Deflate for use with one or more computing systems according to various embodiments of the present disclosure.

FIG. 11 depicts a table-representation of interactions between an operating system (OS) and a processing circuit for one or more computing systems according to various embodiments of the present disclosure.

FIG. 12 depicts a block diagram of an interaction between a memory controller and a dynamic random-access memory (DRAM) for accessing data in one or more computing systems according to various embodiments of the present disclosure.

FIG. 13 depicts memory levels or areas of a memory in one or more computing systems according to various embodiments of the present disclosure.

FIG. 14 depicts a mapping of OS tables and DRAM pages in one or more computing systems according to various embodiments of the present disclosure.

FIG. 15 depicts a flowchart for page management in a three-level memory hierarchy for one or more computing systems according to various embodiments of the present disclosure.

FIG. 16 depicts various CTE tables that can be stored in a DRAM for one or more computing systems according to various embodiments of the present disclosure.

FIG. 17 depicts a block diagram of an example computing system for dynamically managing storage of data in memory based on short and long CTEs according to various embodiments of the present disclosure.

FIG. 18 depicts a flowchart that can be executed by one or more computing systems for managing data access in memory according to various embodiments of the present disclosure.

FIG. 19 depicts an example timing diagram comparing a timeline of a CTE cache miss in one or more computing systems versus previous approaches according to various embodiments of the present disclosure.

### DETAILED DESCRIPTION

Memory can be a costly resource in computing. For example, under many virtual machine (VM) instances in Amazon Web Services (AWS) such as t2, t3, t3a, and 54 g, doubling a VM's memory size while keeping the number of vCPUs the same doubles the total hourly cost of the VM (e.g., going from a 0.5 GB VM with 1 vCPU to a 1 GB VM with 1 vCPU doubles the total hourly cost of the VM). Other large-scale data center operators such as Facebook®, Microsoft®, and Google® also report that memory makes up a large and rising fraction of total infrastructure cost.

To increase effective memory capacity without increasing actual dynamic random-access memory (DRAM) cost, some prior works have explored hardware memory compression. Hardware can be configured to transparently compress DRAM content on-the-fly with a memory controller (MC) evicting/writing back memory blocks to DRAM. To increase effective memory capacity (i.e., to store more values in memory), the MC also transparently migrates compressed data closer together to free up space in DRAM for future data. To migrate data, the MC can take on several operating system (OS) features. For example, the MC can maintain a dynamic, page table-like, fully associative, physical address to DRAM address translation table that can map physical addresses to DRAM addresses. These translation entries are called compression translation entries (CTEs) throughout this disclosure as they are similar to OS page table entries (PTEs). Prior works cache CTEs in the MC via a dedicated CTE cache, similar to a translation lookaside buffer (TLB) caching PTEs.

The physical-to-DRAM address translation for hardware compression increases end-to-end latency of memory accesses, however. This translation takes place serially after the existing virtual-to-physical translation produces a physical address. If that physical address incurs a last-level cache (LLC) miss, and the LLC miss suffers from a CTE miss in the CTE cache, the MC generally has to wait for the missing CTE to arrive from the DRAM before knowing where in the DRAM to fetch the missing data block.

Additionally, some prior works compress and pack/migrate data at a small, memory block-level granularity. However, this can introduce and additional block-level translation after the page-level virtual address translation. In general, the smaller the granularity of address translation, the higher the translation overhead. As such, this additional block-level translation exacerbates the well-known address translation problem for large and/or irregular workloads.

Conventional address translation for an OS typically maps virtual addresses to physical addresses at 4 KB page granularity. OS maintains a page table for each program to map virtual pages to physical pages. Central processing units (CPUs) incorporate a per-core translation lookaside buffer (TLB) to cache recently used page table entries (PTEs). A TLB has a limited size (e.g., 2048 entries), and a TLB miss can trigger the page walk. The page walk performs a sequence of memory accesses to traverse the page table, and each step in a page walk fetches a 64B block of eight PTEs, which is called a page table block (PTB) in this disclosure.

For hardware memory compression, many prior works have explored a MC that transparently compresses content on-the-fly with evicting/writing back memory blocks to DRAM and transparently decompresses DRAM content on-the-fly for every LLC miss. Broadly, prior works on hardware memory compression falls under two broad categories. One body of work compresses memory values to increase effective memory bandwidth. Compressing memory blocks reduces the number of memory bus cycles required to transfer data to and from memory. Another body of work uses compression to increase effective memory capacity by migrating compressed blocks closer to free up a large contiguous space in DRAM for future use. Intuitively, increasing effective capacity requires more aggressive data migration than compressing memory to increase effective bandwidth. The former carries out fully associative data migration in DRAM. In comparison, the latter either keeps memory blocks in place after compression or migrates compressed memory blocks to a neighboring location in DRAM.

To migrate data transparently in hardware, prior works on increasing effective capacity borrow two OS memory management features and implement them in hardware. First, prior works borrow from an OS's free list. A MC maintains a linked-list-based free list to track free space in DRAM at a coarse (e.g., 256B or 512B) granularity called chunks. When detecting that sufficient slack currently exists within the space taken up by a page, prior works repack the page's content closer together to free up chunk(s) to push to (i.e., track at the top of) the free list. When a page becomes less compressible and cannot fit in its currently allocated chunks, prior works pop a chunk from (i.e., stop tracking it in) the free list to allocate the chunk to the page.

Second, prior works borrow from OS page tables. A MC maintains a dynamic, page-table-like, fully associative, physical address to DRAM address translation table that can map any physical address to any DRAM address. These new hardware-managed translation entries are referred to as compression translation entries (CTEs), as they are similar to OS page table entries (PTEs). A MC stores the CTEs in DRAM as a linear 1-level table. Each CTE (a.k.a, meta-data blocks in prior works) contains individual fields to track the DRAM address of individual 64B blocks within a group of blocks. This is because compression ratio varies across blocks; as such, after saving memory through repacking, different blocks start at irregular-spaced DRAM addresses, instead of regular-spaced DRAM addresses like current systems without hardware compression. Prior works cache these CTEs in a dedicated CTE cache, similar to TLBs dedicated to caching PTEs.

As mentioned above, OSes can compress memory and do so in many data centers such as Google® Cloud, IBM® Cloud, and Facebook®, among others. In the eyes of an architect, OS memory compression manages memory as a 2-level exclusive hierarchy: (i) Memory Level 1 (ML1), which can be a memory area, stores everything uncompressed, (ii) Memory Level 2 (ML2), which can be another memory area, stores everything compressed. Accesses to ML1 are overhead-free (e.g., incurs no translation overhead). Accesses to a compressed virtual page in ML2 incurs a page fault to wake up OS to pop a free physical page from ML1's free list and migrate the virtual page to the page.

Because ML1 provides no gain in effective capacity, providing significant gain in overall effective capacity requires ML2 to aggressively save memory from the pages ML2 is storing. As such, ML2 uses aggressive page-granularity compression algorithms, such as Deflate. ML2 also keeps many free lists, each tracking sub-physical pages of a different size, to store any compressed virtual page in a practically ideal matching sub-physical page.

ML2 gracefully grows and shrinks relative to ML1 with increasing and decreasing memory usage. When everything can fit in memory uncompressed, ML2 shrinks to zero bytes in physical size so ML1 can have every physical page. Specifically, when ML2's free list(s) get large (e.g., due to reducing memory usage), ML2 donates free physical pages from its free list(s) to ML1. An OS can also grow an ML1 free list, when it gets small, by migrating cold virtual pages to ML2. Migrating a virtual page to ML2 shrinks one of ML2's free lists. If a ML2 free list gets empty, ML1 gives a cold victim's physical page to ML2 (i.e., track them in ML2 instead of ML1), so that ML2 can compress the virtual pages to free space to grow ML2's free list(s).

Large workloads (i.e., ones with large memory footprint) are ubiquitous in today's computing landscape; examples include graph analytics, machine learning, and in-memory databases. However, large workloads suffer from high address translation overhead because their PTEs are too numerous to fit in TLBs. Similarly, the PTEs of workloads with irregular access patterns also cache poorly in TLBs. As such, many prior works have explored how to improve address translation for large and/or irregular workloads in the context of conventional systems without hardware memory compression.

Therefore, embodiments of the present disclosure address the problem of high address translation overheads that large and/or irregular workloads suffer under hardware memory compression. The embodiments address the problem of high address translation overheads that large and/or irregular workloads suffer under hardware memory compression for capacity. It should be noted that just like how they suffer from high PTE miss rates in TLBs, they also suffer from high CTE miss rates under hardware memory compression. Making matters worse, prior works on hardware memory compression translate from physical to DRAM addresses at memory block granularity, instead of page granularity. The finer the translations, the higher the translation miss rate. It should be noted that just like how these workloads suffer from high PTE miss rates, they also suffer from high CTE miss rates. Further, prior works migrate memory content at memory block granularity, which requires much more fine-grained address translation than existing virtual-to-physical translation, which typically operates at 4 KB page granularity. In general, the finer the coverage of translations, the less cacheable the translations become, and higher the translation miss rate.

The embodiments incorporate an OS-inspired approach: to save memory from cold (i.e., less recently accessed) pages without saving memory from hot (i.e., recently accessed) pages by keeping the hot pages uncompressed, for example, such as in OS memory compression. Saving memory from cold, but not hot, pages can mitigate the block-level translation overhead due to saving memory from hot pages in hardware. This type of hardware memory compression faces two challenges, however. One challenge can arise after a compressed cold page becomes hot again. In such a case, migrating the page to a full 4 KB DRAM location still adds another level (albeit page-level, instead of block-level) of translation for future accesses to the newly hot page. Another challenge can arise from the case that only compressing cold pages requires very aggressively compressing cold pages to achieve the same total memory savings as in the prior works' approach of saving memory from all (both cold and hot) pages. Decompressing aggressively compressed pages can incur high latency overhead (e.g., greater than 800 ns in IBM®'s state-of-the-art ASIC Deflate).

In relation to the embodiments, it is observed that CTE misses typically occur after PTE misses in TLB because CTEs, especially the page-level CTEs under an OS-inspired approach, have similar translation reach as PTEs. Second, it is observed that PTBs are highly compressible because adjacent virtual pages often have identical status bits and the most significant bits in physical page numbers are unused. As such, to hide the latency of CTE misses, the embodiments transparently compress each PTB in hardware to free up space in the PTB to embed the CTEs of the 4 KB pages (i.e., either data pages or page table pages) that the PTB points to. This enables each page walk to also prefetch the matching CTE required for fetching from DRAM either the end data or the next PTB.

To address the second challenge described above, the embodiments modify IBM®'s state-of-the-art ASIC Deflate design, which was designed for both storage and memory, and specialize it for memory. Particularly, large design space exploration was performed across many dimensions of hardware configurations available under Deflate and across diverse workloads. The embodiments include an ASIC Deflate specialized for memory that is 4× or 4 times as fast as the state-of-the-art Deflate when it comes to memory pages.

The embodiments address the translation problem faced by large and/or irregular workloads when using hardware memory compression to improve effective memory capacity. The embodiments identify that CTE cache misses mostly follow TLB misses (e.g., for around 89% of the time, on average). Thus, the embodiments propose embedding CTEs into PTBs to enable accurate prefetch of CTEs during the normal page walks after TLB misses. The embodiments include a specialized ASIC Deflate for memory that can decompress 4 KB memory pages 4× as fast as the best general-purpose Deflate.

The embodiments implement hardware memory compression via another OS feature: only save memory from cold (i.e., less recently accessed) pages without saving memory from hot (i.e., recently accessed) pages (e.g., keep the hot pages uncompressed), like OS memory compression. When hardware does not save memory from hot pages, hardware can lay out hot pages' memory blocks regularly either like uncompressed memory or like compressing memory for expanding effective bandwidth. For hot pages, which are important to performance, doing so helps to avoid the overhead of fine-grained block-level translation.

Specifically, avoiding block-level translation can significantly increase the translation reach of each CTE and, therefore, significantly reduce CTE cache miss rate. In a prior work such as Compresso, each 64B CTE cacheline only translates for one 4 KB physical page due to storing a translation for every block in the page. After switching over to page-level translation like OS, each 64B CTE cacheline can translate for eight pages, like how a PTB translates for eight virtual pages. In some examples of the embodiments, switching from block-level translation to page-level translation eliminates 40% of CTE misses on average, while simply quadrupling the size of the CTE cache only reduces CTE miss rate by 13% (from 34% down to 29.5%). Page-level translation is so effective due to increasing effective CTE cache size by 8× and better exploiting spatial locality (i.e., fetching from DRAM a CTE block that translates at page level equates to fetching eight adjacent CTE blocks that translate at block level).

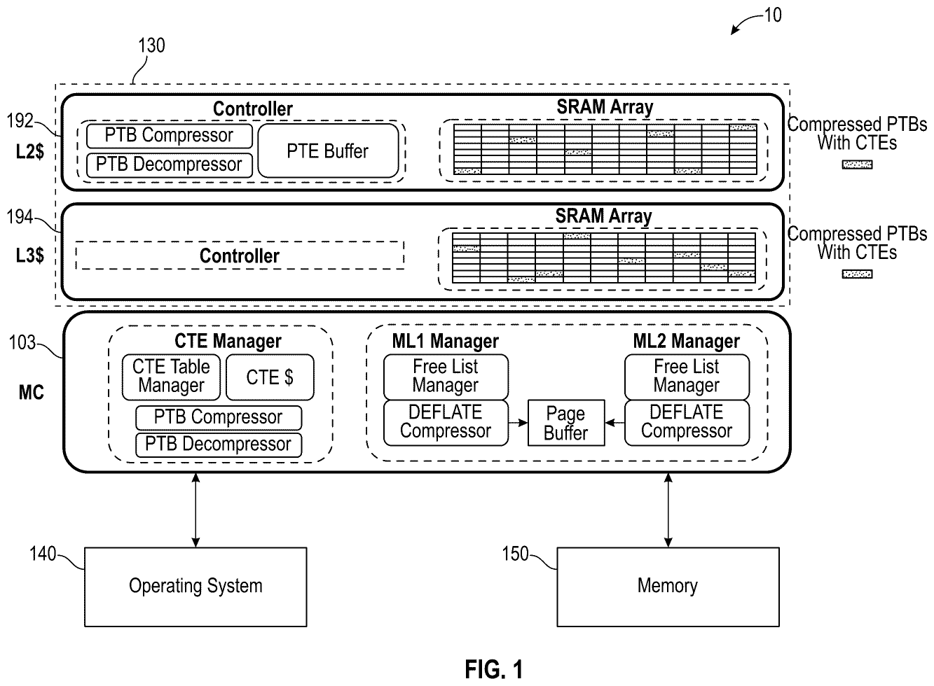

Referring now to the drawings, FIG. 1 depicts an example computing system for dynamically managing storage of data in memory according to various embodiments of the present disclosure. It should be noted that FIG. 1 is not exhaustively illustrated, meaning that other components not shown in FIG. 1 can be included or relied upon in some cases. Similarly, one or more components shown in FIG. 1 can be omitted in some cases. A computing system 10 includes an OS 140, a memory 150, and a processing circuit 103 that is in data communication with the OS 140 and the memory 150. The computing system 10 can also include a CPU 130 which is in data communication with the processing circuit 103, the OS 140, and the memory 150. The CPU 130 can include various caches, such as an L2 cache 192 and an L3 cache 194, each of which can have its own controller and static random-access memory (SRAM) array that includes compressed PTBs with CTEs. The L2 cache can include a PTB compressor, a PTB decompressor, and a PTE buffer. The CPU 130 can include other caches such as an L1 cache and other components such as a memory management unit (MMU) and can be configured to execute various actions relating to storage of memory and access of memory in connection with the OS 140 and the processing circuit 103.

The memory 150 can be embodied as one or more memories and can include dynamic random-access memory (DRAM), static random-access memory (SRAM), and non-volatile memory (NVM), among others. The memory 150 can store physical pages that are mapped 1:1 with virtual OS pages that are managed by the OS 140.

The OS 140 can include various types of OSes such as Windows, macOS, and Linux, among others. The OS 140 is configured to receive actions from a user or an application/program to manage various types of data that can be stored in the memory 150. For example, a user may access an application such as a game, a photoshop application, a chatting application, etc., via an executable (EXE) file. The OS 140 can be configured to assign and manage virtual memory in the form of pages to the application that is being used, and the virtual memory addresses of the virtual pages can be translated into machine-physical addresses to be stored in the memory 150 by the processing circuit 103.

The processing circuit (PC) 103 includes a memory controller for dynamically managing storage of data in the memory 150 based on instructions received from the OS 140. For example, as described above, the PC 103 can manage storage of data associated with an application or program in the memory 150, to increase memory capacity of the memory 150 and speed of access of the stored data in the memory 150. In some embodiments, the PC 103 includes a CTE manager, which includes a CTE table manager, a CTE cache, a PTB compressor, and/or a PTB decompressor. The PC 103 can also include a memory level manager (e.g., “ML1 manager,” “ML2 Manager,” etc.), which are associated with storage and management of data in the memory 150 in different memory levels or memory areas. Each memory level manager can include a free list manager and a Deflate compressor, and each memory level manager can be in data communication with each other via a page buffer.

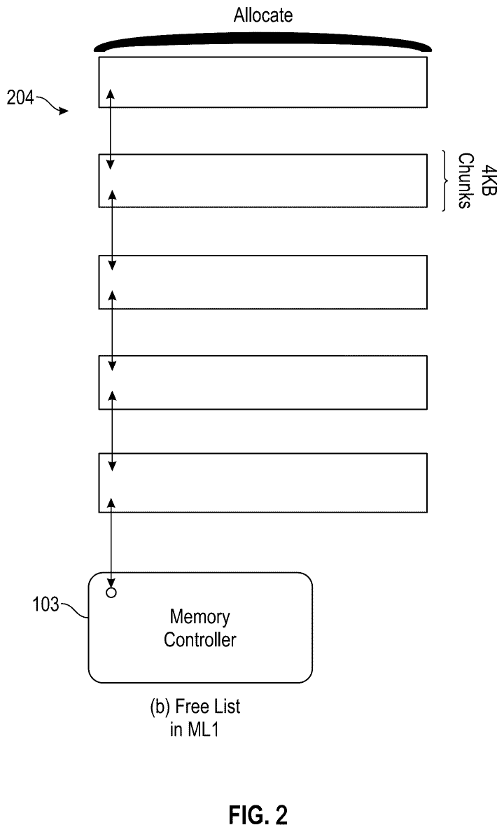

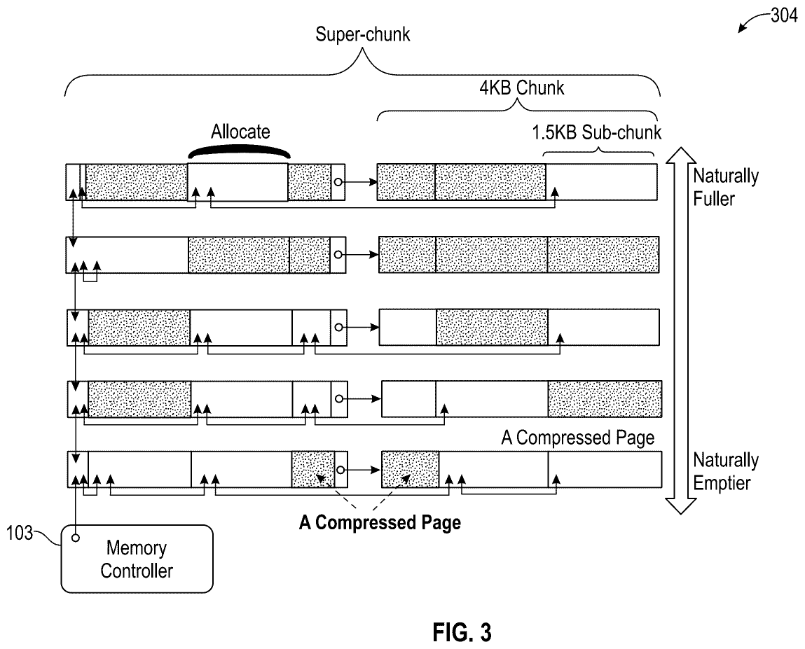

FIG. 2 depicts a free list in a first ML for use in one or more computing systems, and FIG. 3 depicts a free list in a second ML for use in one or more computing systems, according to various embodiments of the present disclosure. The computing system 10 can be configured to manage the memory 150 in different memory areas that may be non-contiguous and arbitrarily interleaved like OS memory compression, with simple adaptations. One adaptation is to simplify CTEs. In particular, instead of finely tracking individual memory blocks, the computing system 10 can be configured to track a single 4 KB page worth of content collectively at coarse granularity, just like a PTE. Specifically, each CTE can be configured to only record a starting DRAM address of an entire page, without recording any individualized tracking for every block in the page.

FIG. 2 depicts a free list 204 for ML1 (e.g., the first ML) in the memory 150, and FIG. 3 depicts a free list 304 for ML2 (e.g., the second ML) in the memory 150, where ML1 and ML2 refer to different memory levels or areas in the memory 150. The ML2 memory level in the memory 150 can require multiple free lists, where each free list can track free equally-sized sub-chunks. Each sub-chunk can store an entire compressed page. Equally-sized sub-chunks can be created fragmentation free by evenly dividing a group of M interlinked chunks, which can be referred to as a super-chunk, into N sub-chunks, where N>M and N, M are chosen to minimize (4 KB·M)·modN.

FIG. 3 shows an example where the free list 304 is tracking 1.5 KB sub-chunks. When all sub-chunks in a super-chunk become free (e.g., the compressed pages they store have all migrated to ML1 over time), the chunks in the super-chunk are returned to ML1's free list (e.g., the free list 204). The super-chunks toward the bottom of an ML2 free list (e.g., the free list 304) naturally tend to be emptier than super-chunks toward the top. This generally is because A) ML2 usually or always allocates sub-chunks from the top of ML2 free list(s) to handle migration to ML2 and B) ML2 tracks at the top of ML2 free list(s) super-chunks that transition from having no free sub-chunk to having one free sub-chunk (e.g., after a page migrates to ML1).

Besides CTEs and free lists, the computing system 10 is configured to track and generate a recency list to track the recency of pages stored in ML1 and/or ML2. In one or more embodiments, the processing circuit 103 can be configured to generate and track the recency list for data stored in the ML1 and/or ML2 for the memory 150. This recency list is a doubly linked list and each recency list element can track a page in ML1 by recording a page's physical page number (PPN). The head and tail of a recency list tracks the hottest and coldest pages in the ML1, respectively. The processing circuit 103 can be configured to cause the ML1 to update its the recency list for a small (i.e., 1% of) fraction of randomly chosen accesses to the ML1. When updating the recency list for an access to the ML1, the ML1 can be configured to move the accessed page's list element to the hot end (e.g., recently or frequently accessed end) of the list. The ML1 can be configured to evict victims from the cold end (e.g., less recently or less frequently accessed end) of the recency list. In the uncommon case that the victim turns out to be incompressible, the ML1 retains the page in ML1, and the ML1 can simply remove\ the page from the recency list to avoid uselessly compressing it again. As subsequent writebacks may increase a page's compression ratio, the ML1 adds an incompressible page back to the recency list at 1% probability after a writeback to an incompressible page. The ML1 can record whether a page is incompressible via an ‘isIncompressible’ bit in each CTE.

While ML1 is uncompressed in an OS, in hardware, the processing circuit 103 can be configured to compress the ML1 in the memory 150 to increase effective memory bandwidth. Additionally, the processing circuit 103 can be configured to apply available memory compression techniques such as various memory compression algorithms for improving bandwidth to ML1.

The computing system 10 can be configured to remedy challenges associated with demand-adaptive memory compression in hardware. One challenge can include that after compressed cold pages are accessed again, migrating them from the ML2 to the ML1 can still add another level (albeit page-level, instead of block-level) of translation for future accesses to multiple or all pages in ML1. Additionally, another challenge can include that only compressing cold pages requires aggressively compressing cold pages to achieve high overall memory savings. Decompressing aggressively compressed pages for every access to the ML2 can be very slow.

In OS memory compression, accesses to ML1 incur no overhead. When OS migrates a virtual page from ML2 to a free physical page in ML1, OS directly records the new physical page's PPN in the virtual page's PTE. As such, future accesses to the virtual page in ML1 requires the same amount of translation as a system that turns off memory compression. However, when hardware memory compression migrates a page from ML2 to ML1 after a program accesses the page, hardware cannot directly update the program's PTE because PTEs are OS-managed. Raising an interrupt to ask OS to update the PTE for hardware would defeat the main purpose of hardware memory compression-avoid the costly page faults under OS memory compression. Instead, hardware tracks the page's new DRAM location through a new layer of translation (i.e., through CTEs). As such, hardware has to use the PPN recorded in the page's PTE to indirectly access a CTE to obtain the data's DRAM address. This can require a new level of serial page-level translation, unlike ML1 accesses under OS compression. For various workloads, this added page-level translation can cause about 20% of LLC misses to suffer from CTE misses.

A latency bottleneck for ML2 in hardware compression is decompressing aggressively compressed pages when they are accessed in ML2. OSes typically use aggressive page-granular compression, such as Deflate, to save memory in ML2. For decades, Deflate has been used across many application scenarios (e.g., file systems, network, memory, etc.). Due to Deflate's high and robust compression ratio, IBM® integrates ASIC Deflate into Power9 and z15 CPUs. This state-of-the-art ASIC Deflate achieves a peak throughput of 15 GB/s for large streams of data. However, it has a setup time (T0) of 650-780 ns for each new independent input (e.g., a new independent page). This delay can be crippling for small inputs, such as 4 KB memory pages. This long delay also limits the bandwidth for reading and writing 4 KB compressed pages to only 4 GB/s and 2 GB/s per module, respectively. This amounts to a mere 16% and 8% bandwidth of a DDR4-3200 memory channel. While long latency and low bandwidth is acceptable for ML2 accesses under OS compression, where overall performance is limited by software overheads, they are inadequate for hardware memory compression.

To effectively address the problem of long-latency serial translation for accesses to ML1 during CTE misses, the computing system 10 can be configured to parallelize data access with a corresponding CTE access instead of the conventional approach of waiting for the missing CTE to arrive from DRAM and then using the CTE to calculate the DRAM address to serve the L3 miss. The computing system 10 can be configured to execute both DRAM accesses in parallel, thereby effectively hiding a CTE miss latency from a total DRAM access latency for serving an L3 miss request. Foundations for parallelizing DRAM accesses for CTE and for an actual L3 miss came from observations that CTE misses typically occurred immediately after PTE misses. This is also true for previously discussed OS-inspired approaches to hardware memory compression, where each 8B CTE translates for a 4 KB page. Similarly, each memory level corresponding to N+1 PTE (e.g., L2 PTE) tracks 4 KB worth of level N PTEs, while each L1 PTE tracks 4 KB of data (or instructions). Due to CTEs and PTEs providing the same translation reach, accesses that cause PTE misses in TLB will likely also cause CTE misses in CTE cache. Additional observations included that each PTB (i.e., a 64B worth of PTEs) is highly compressible because, intuitively, adjacent virtual address ranges often have identical status bits. Moreover, many bits in PPN are also identical, depending on the actual amount of DRAM currently installed in a system. For example, in a machine with 4 TB of OS physical pages, the most significant 10 bits of a PPN are almost always identical (e.g., all zeroes or reused as identical extended permission bits by Intel® MKTME).

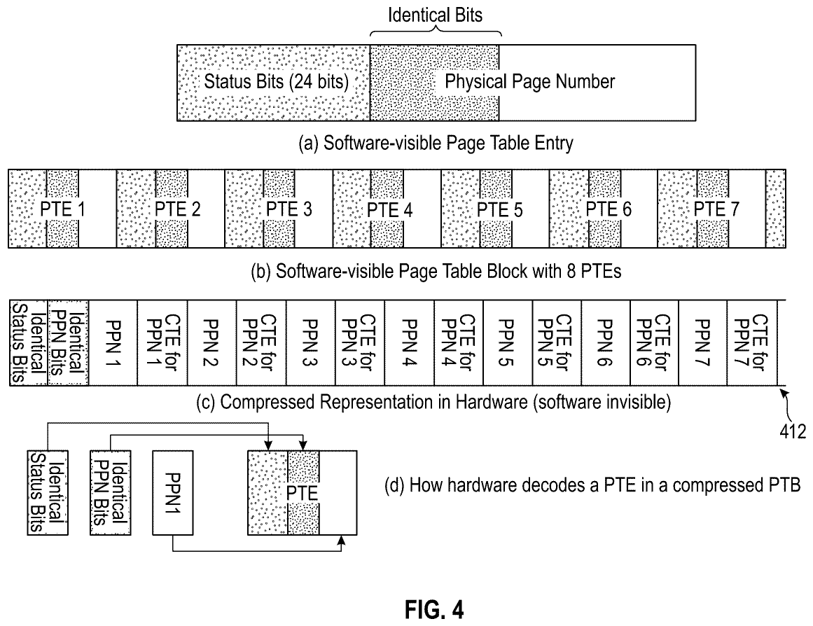

FIG. 4 depicts a hardware-compressed PTB encoding for use with one or more computing systems according to various embodiments of the present disclosure. The computing system 10 can be configured to compress each PTB in hardware to free up space in a respective PTB to embed a CTE of one or more 4 KB pages (i.e., either data pages or page table pages) that the PTB refers to. The compression of the PTB and embedding of a respective CTE enables a triggered page walk access to also prefetch a matching CTE required either for the next page walk access (i.e., to a next PTB) or for actual data or instruction access after the walk. In FIG. 4, a conventional page table entry (a), a conventional PTB with multiple PTEs, and a compressed PTB 412 with embedded CTEs are depicted. For example, “CTE for PPN1” translates “PPN1” to a DRAM address. In one example, the computing system 10 can compress a PTB if the status bits across 8 PTEs are identical. To compress a PTB, the computing system 10 can be configured to record the status bits only once and truncate leading identical bits in PPNs according to how much memory is installed.

For each PTE in the compressed PTB 412, the computing system 10 is configured to opportunistically store in the compressed PTB 412 a CTE responsible for translating a PPN that the PTE contains into a DRAM address. As such, as a page walker fetches a PTB, the CTE for the next access (i.e., either the next page walker access or the end data access) becomes available at the same time as the PPN for the next access. Directly having in the PTB the CTE needed for the next access can eliminate the need to serially fetch and wait for a CTE to arrive from DRAM (e.g., the memory 150) before knowing the next DRAM address to access.

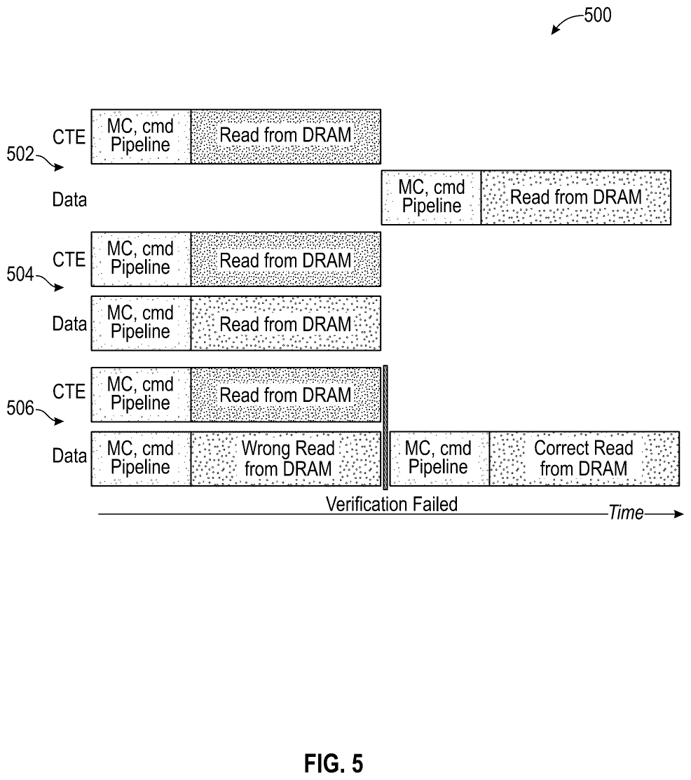

FIG. 5 depicts a timeline of various functions executable by one or more processing circuitries, according to various embodiments of the present disclosure. A practical challenge that can arise after migrating a page (e.g., from ML1 to ML2 for the memory 150 after the page becomes cold) is that a corresponding CTE embedded in the page's PTB should be updated. However, hardware cannot easily use a PPN of the migrating page to find/access the page's PTB(s). The computing system 10 is configured to address this challenge by updating applicable CTEs in a corresponding PTB later when the PTB is naturally accessed by the page walker, instead of updating it at the time of migrating the page (e.g., from ML1 to ML2 and vice versa). However, this update process can cause the corresponding CTE to be out-of-date when a page walker first accesses the PTB after migration. To ensure correctness, the computing system 10 can be configured to also access the correct CTE in the memory 150 (or in a CTE cache) in parallel to verify the correctness of the DRAM access. Timeline 500 compares and contrasts how the computing system 10 can serve an LLC miss that also misses in a CTE cache with a baseline approach 502, a common-case approach 504 executed by the computing system 10 that arises in over 93% of the time in one example, and an uncommon-case approach 506 executed by the computing system 10 that arises in less than 3% of the time in one example. The timeline 500 corresponds to functions that may be executed for serving LLC misses that also suffer from a CTE cache miss. In the timeline 500, the sum of the common-case approach 504 and the uncommon-case approach 506 does not add up to 100% because there may be another uncommon-case scenario that the PTB does not currently embed any CTEs, as opposed to embedding the right or wrong CTE.

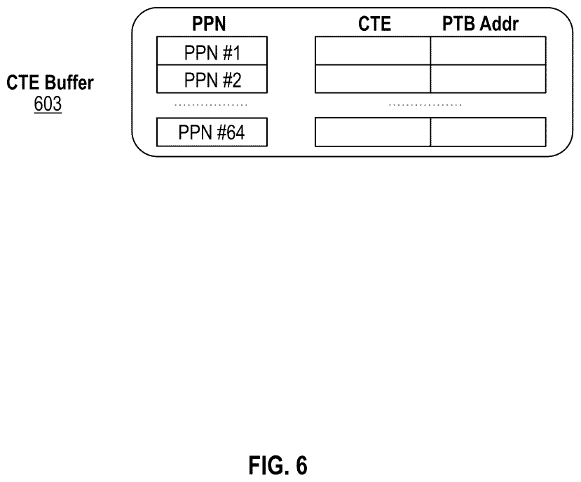

FIG. 6 depicts a CTE buffer that can be used by one or more computing systems according to various embodiments of the present disclosure. After a TLB miss for instruction X, for example, if a page walker accesses an L2 cache (e.g., the L2 cache 192), the L2 cache can buffer into a temporary buffer for every CTE within the accessed PTB. This temporary buffer can be referred to as a CTE buffer 603, and the CTE buffer 603 can be configured to insert each CTE as a new key value pair. The key is a PPN that a PTE for the accessed PTB records, and a PPN number or value can be mapped to a CTE address and a PTB address (e.g., physical address of the PTB) as depicted in FIG. 6.

When the L2 cache receives another page walker access or the end data (or instruction) access for instruction X, the L2 cache can be configured to extract a PPN from the received request to lookup via the CTE buffer 603 to obtain the corresponding CTE for the processing circuit 103 to translate the PPN. If the request misses in the L2 cache, the L2 cache can be configured to forward the request to an LLC, as usual, and can be configured to piggyback the CTE in the request. If the LLC also misses, the LLC can forward the request and the piggybacked CTE to the processing circuit 103.

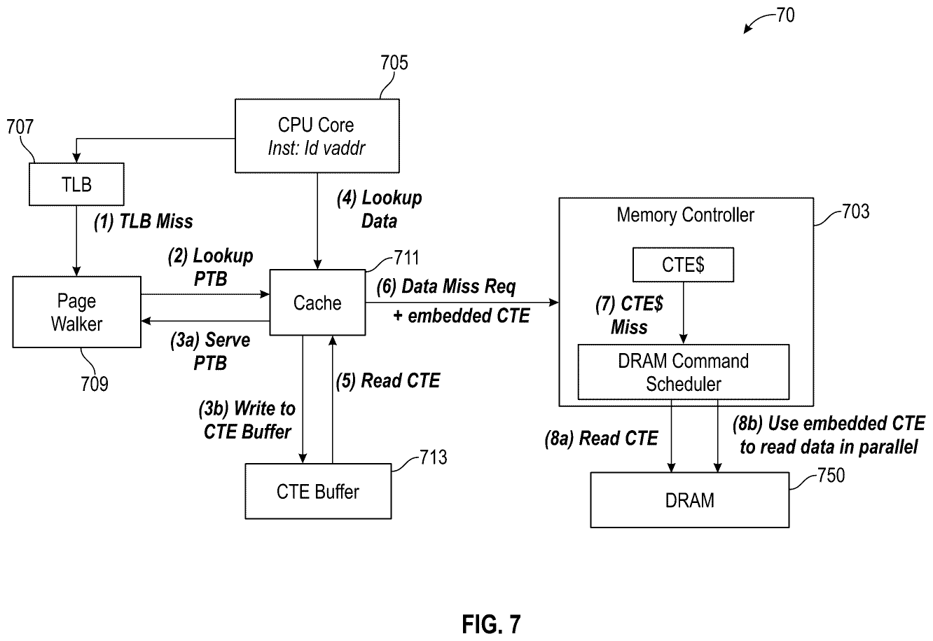

FIG. 7 depicts a computing system for obtaining embedded CTEs to access data in a memory, according to various embodiments of the present disclosure. The computing system 70 includes a memory 750, a CPU 705, a TLB 707, a page walker 709, a cache 711, a CTE buffer 713, and a processing circuit 703. The processing circuit 703 is similar to the processing circuit 103 and can include a MC, and the memory 750 is similar to the memory 150 and can include DRAM and other types of memory. The computing system 70 is configured to obtain embedded CTEs to access data in the memory 750 in parallel with accessing an actual CTE in the memory 750. FIG. 7 additionally depicts various steps that can be performed by individual components within the computing system 70. For example, “a” and “b” steps corresponding to the same number can be performed in parallel.

When receiving a request from the LLC, the processing circuit 703 can be configured to first scan a CTE cache (e.g., CTE$ stored in the MC) by extracting a PPN from the request to access the CTE cache. If the request hits in the CTE cache, the processing circuit 703 is configured to use a corresponding CTE from the cache to translate the request's physical address to a DRAM address to access the memory 750. If the request misses in the CTE cache, two cases can occur. The uncommon case is that the request has no embedded CTE. In such a case, the processing circuit 703 can be configured to access a corresponding CTE in the memory 750 and then serially access the memory 750 to service the LLC miss. The common case is that the request has an embedded CTE, and the processing circuit 703 can use the embedded CTE to speculatively translate the LLC's request to DRAM address to access the memory 750 in parallel with accessing the actual CTE in the memory 750. This common case is illustrated in FIG. 7. When both DRAM accesses complete, the processing circuit 703 is configured to check whether the correct CTE from the memory 750 matches the embedded CTE. In they match, which is the common case, the processing circuit 703 can directly respond to the LLC. If they do not match, which is the uncommon case, the processing circuit 703 is configured to use the correct CTE to translate the LLC request and re-access the memory 750 (e.g., see the uncommon-case approach 506).

In both cases above, the processing circuit 703 is configured to piggyback the correct CTE in the response back to the LLC and the L2 cache. When receiving a response, the L2 cache is configured to extract the PPN from the response to look up the CTE buffer 713. On a hit of the CTE buffer 713, if a CTE buffer entry has a mismatching CTE or has no CTE, the L2 cache stores the correct CTE into the entry and uses the PTB physical address that the element records to fetch and update the PTB with the incoming CTE.

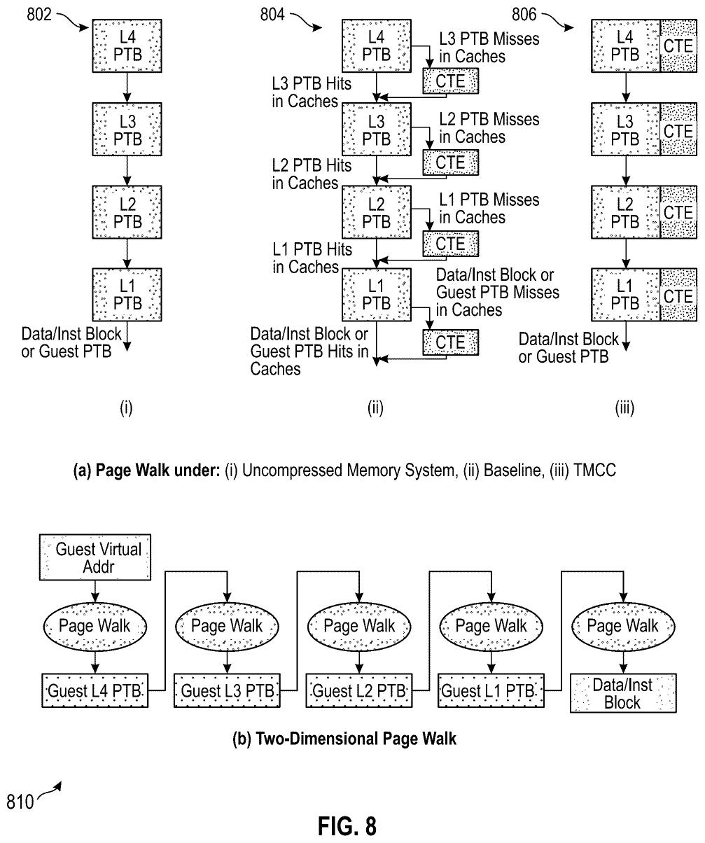

FIG. 8 depicts a series of flowcharts that can be executed by one or more computing systems according to various embodiments of the present disclosure. Flowcharts 802, 804, and 806 depict a contrasting page walk under an uncompressed memory system, a baseline, and the computing systems 10 or 70, respectively. Flowchart 810 depicts a flowchart of a 2D page walk for a virtual machine which can be executed in the computing systems 10 or 70. Embedding CTEs in PTBs for the computing systems 10 or 70 not only reduces the latency to fetch data/instruction from the memory 150 or 750 at the end of a page walk but can also reduce latency to fetch PTB blocks from the memory 150. In other words, embedding CTEs in PTBs can benefit an entire page walk (e.g., see the flowchart 806). Embedding CTEs in PTBs also benefits 2D page walks for VMs as depicted in flowchart 810. Each 2D page walk in the flowchart 810 requires multiple regular page walks that only use host PTBs, similar to a page walk for a native application. As such, the computing systems 10 or 70 can be configured to carry out the same actions during each page walk within a 2D page walk as a regular page walk.

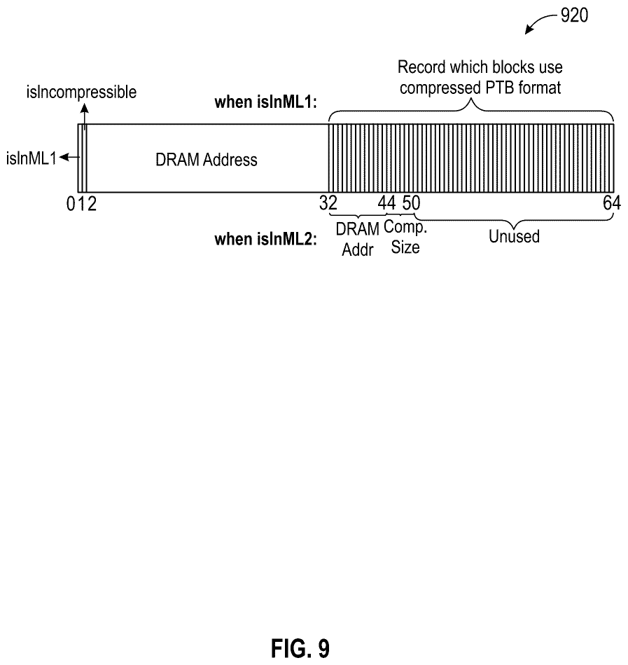

FIG. 9 depicts an internal layout of a CTE for one or more computing systems according to various embodiments of the present disclosure. For example, a CTE 920 can be embedded in various PTBs for the computing systems 10 and/or 70. In reference to the computing system 10 (also applicable to the computing system 70), the processing circuit 103 can be configured to embed the CTE 920 to one or more compressed PTBs in the memory 150. In one example, to track which blocks in DRAM are encoded via the compressed PTB encodings (e.g., see the compressed PTB 412 at FIG. 4), each CTE such as the CTE 920 can contain a bit vector of 32 bits. It should be noted that in other examples, the CTE 920 can contain a bit vector of different bits. Each bit can track whether two adjacent blocks in a page are both currently using the compressed PTB encoding (e.g., the compressed PTB 412). When one block in a pair of adjacent blocks undergoes an encoding change (i.e., from uncompressed to compressed or vice versa), the processing circuit 103 can enact the same encoding change for the other block when it writes to the memory 150 the original block with the changed encoding.

It should be noted that compressing memory blocks using the described compressed PTB encodings only affects encoding of individual memory blocks in a page in the ML1 for the memory 150, without affecting their DRAM location. For example, the 32-bit vector for the CTE 920 serves to record the format of the blocks in each page in the ML1 for the memory 150, and not to migrate the corresponding blocks. In one example, the computing system 10 does not perform any block-level translations, even for compressed PTBs. After fetching from the memory 150 a memory block encoded in compressed PTB format, the processing circuit 103 can be configured to transmit the block back to the LLC in compressed format. For the computing system 10, the only compressed content or data on-chip are PTBs (i.e., cachelines accessed by the page walker). Every L2 and L3 cacheline has a new data bit to record whether the cacheline is compressed. Conversely, when L3 writes back a dirty cacheline to the processing circuit 103, the processing circuit 103 can check the new data bit to set the CTE's bit vector accordingly.

Referring still to the computing system 10, apart from the processing circuit 103, the L2 cache 192 can include the PTB compressor and the PTB decompressor as described in relation to FIG. 1. When an L1 cache or a page walker requests a block from the L2 cache 192 and an L2 copy is compressed (i.e., the new data bit in the copy is set as described above), the L2 cache 192 can be configured to reply with a decompressed copy because all software initiated memory accesses pass through the L1 cache. This reply of a decompressed copy to the L1 cache ensures CTEs embedded in PTBs are invisible to software, such as the OS 140. When the L2 cache 192 receives from the L1 cache a dirty eviction, the L2 cache 192 checks whether the dirty block's value is compressible under the compressed PTB format. If so and if the L2 copy is currently compressed, the L2 cache 192 copies into the incoming dirty block any embedded CTEs held in the stale L2 copy (note that L2 is inclusive of L1) to seek to preserve the embedded CTEs when the OS 140 modifies a PTB (e.g., to remap a virtual page elsewhere). Additionally, when receiving an uncompressed block from the L3 cache 194, if the requester is the page walker, the L2 cache 192 can be configured to compresses the block before caching the block. The foregoing description describes how the computing system 10 initially compresses PTBs in a PTB page when the OS 140 creates the PTB page or migrates the PTB page to a new address.

Compression can only free up limited space in each PTB. As such, the computing system 10 can be configured to only embed into PTBs truncated CTEs, with only enough bits to identify a 4 KB DRAM address range. In one example, assuming each MC manages up to 1 TB of DRAM, each truncated CTE is only log 2 (1 TB/4 KB)=28 bits. Assuming the computing system 10 enables up to 4× physical pages in the OS 140, the computing system 10 can embed 8 CTEs in the PTB under this configuration (e.g., for all 8 PTEs). In bigger machines with bigger PPNs, however, each compressed PTB cannot fit eight CTEs. For systems with 4 TB and 16 TB of DRAM, each compressed PTB can only fit seven and six CTEs respectively. Decompressing PTBs can take ≤1 cycle. The computing system 10 may only need wiring to concatenate plaintext (e.g., see FIG. 4). Each CTE buffer may have 64 entries and require a total of ˜1 KB.

By migrating memory content at page granularity instead of block granularity, the computing system 10 can reduce the size of each page's CTE from 64B to 8B. Assuming that the OS 140 boots up with 4×OS physical memory as DRAM size in one example, total size of all CTEs in DRAM can reduce from 6.25% to only 0.78%. The recency list used by the computing system 10 can use 0.4% of DRAM in one example.

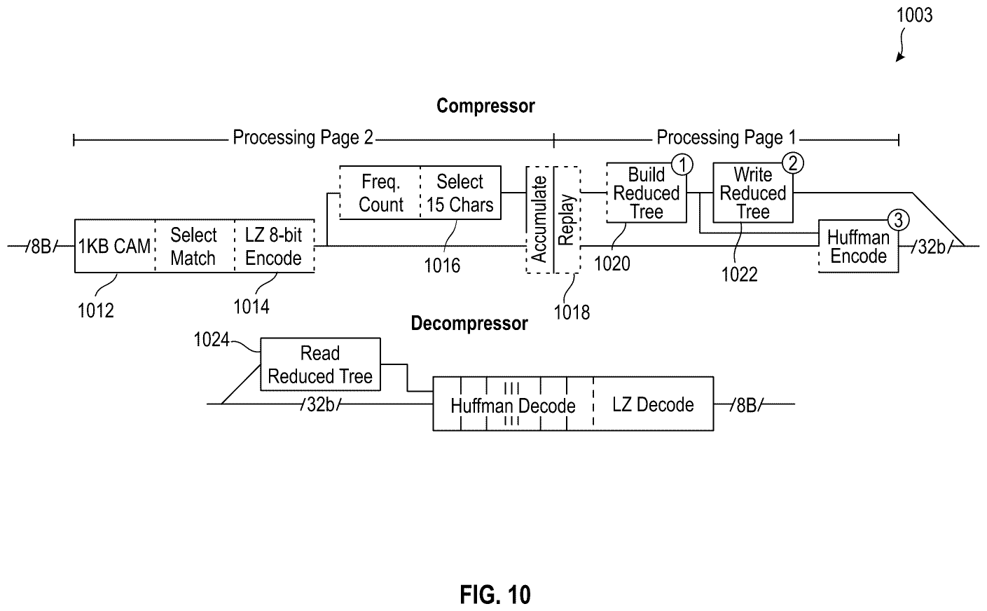

FIG. 10 depicts a Deflate for use with one or more computing systems according to various embodiments of the present disclosure. For example, a Deflate 1003 can include a compressor and a decompressor, which can be implemented with the computing system 10 as improvements upon the ASIC Deflate from IBM®. Modules 1012, 1014, 1016, 1018, 1020, 1022, and 1024 are substantially modified or new compared to the ASIC Deflate from IBM®. Each vertical dashed line separates two stages that are pipelined with respect to one another. Each vertical solid line separates two modules that run serially one after the other (i.e., the earlier module generates and buffers all of its outputs before passing them to the next module). The Deflate 1003 specialized for memory can decompress each 4 KB page in ˜¼^{th} the time as the state-of-the-art ASIC Deflate from IBM®, while providing similar compression ratio. The Deflate 1003 maximizes throughput without reducing the compression ratio by operating both Lempel-Ziv (LZ) and Huffman concurrently by using them to process two or more independent memory pages. This can require adding a buffer to buffer the LZ output in various cases.

The following description reiterates some of the functionality of the computing system 10, which can largely be controlled by operation of the processing circuit 103.

The computing system 10 can be configured to generate a unified CTE table and store CTEs therein where each CTE translates for a 4 KB OS page. This is a flat table, where the n^{th} CTE corresponds to the n^{th} OS page. As each CTE in the computing system 10 can be 8B long, a 64B memory block of the CTE table can stores 8 CTEs. At the time of a CTE cache miss, the processing circuit 103 can fetch one 64B memory block from the CTE table. This memory block is referred to as a CTE block.

The computing system 10 can be configured to manage free space in the memory 150. To track free memory, TMCC maintains a linked list of free 4 KB DRAM pages called the free list, as described in connection with FIG. 1. The computing system 10 also has many other free lists that track irregular-sized free spaces of <4 KB, and each list can track free spaces of a specific size (e.g., 1.5 KB).

The computing system 10 can be configured to manage in-use space in the memory 150 such as memory that is not part of any of the free lists is in-use. When a memory request accesses the data in an ML2 page (i.e., a compressed page), the computing system 10 expands the page into a free 4 KB DRAM page from the free list. When compressing an uncompressed page in the ML1 of the memory 150, the computing system 10 can store the newly compressed page into a tightly-fitting irregular free space tracked by one of the free lists.

The computing system 10 can be configured to compress least-recently-used ML1 Pages. To select a victim for compression, the computing system 10 maintains a recency list for tracking all uncompressed pages. Once every 100 memory requests, the computing system 10 updates the list's head to point to this most-recently accessed page. This naturally causes less-recently accessed pages to drop down in the list so that the list's tail points to the least-recently accessed page.

The computing system 10 can be configured to apply demand-adaptive compression. For example, the computing system 10 can be configured to adaptively compresses data in response to memory pressure to maintain 16 MB of free DRAM pages in the free list. When free memory is <16 MB, the processing circuit 103 can be configured to compress pages asynchronously (i.e., in the background) by repeatedly compressing pages from the tail of recency list and then using the freed-up space to replenishes the free list.

In some embodiments, the computing system 10 can be configured to use a combination of long translations and short translations for the CTEs that map to the pages stored in the memory 150. For example, in one embodiment, the computing system 10 can be configured to use short translations on uncompressed pages (i.e., for pages stored in the ML1 of the memory 150) as they are hot or more frequently or recently accessed. Being smaller, short translations can provide much higher CTE cache hit rate because a CTE cache can store many times more short translations than long translations. Meanwhile, the computing system 10 can be configured to use long translations on compressed pages (i.e., the ML2 of the memory 150) to use all compression-freed spaces in memory.

In another embodiment, the computing system 10 can be expanded so that the processing circuit 103 can include an “ML3 Manager” for storing pages in a third ML (e.g., ML3) in the memory 150 to minimize costly bandwidth overheads. For example, when using long CTEs for all pages (i.e., both the ML1 and the ML2), after a compressed page in the ML2 becomes hot again due to an access, the page can expand directly to any free DRAM page that is being tracked by the free list by the processing circuit 103. When each uncompressed page uses the short CTE, however, each of the few possible locations that the page's short CTE can address/encode is likely to be already in use, especially in a highly-occupied memory system that needs compression. As such, expanding an ML2 page to the ML1 would require first moving one of the pages currently occupying one of these memory or DRAM pages to a free DRAM location somewhere else and then expand the accessed page into the freed-up DRAM page. Having to move two pages per page expansion can double the bandwidth overhead of page expansions over always using long CTEs.

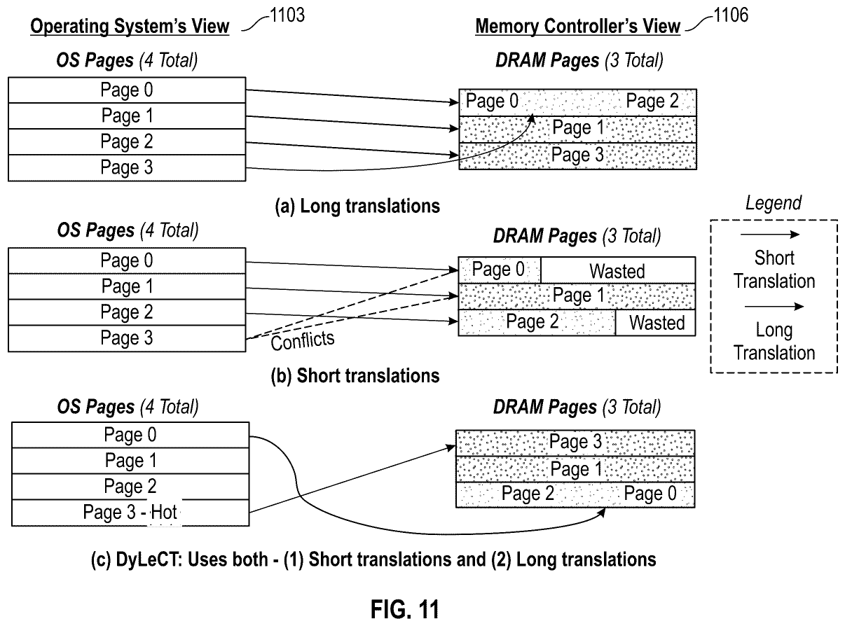

FIG. 11 depicts a table-representation of interactions between an OS and a processing circuit for one or more computing systems according to various embodiments of the present disclosure. For example, an OS view 1103 can correspond to a table-representation of the view of the OS 140, and a MC view 1106 can correspond to a table-representation of the view of the processing circuit 103. As can be seen, long translations provide full freedom of data placement to fully use all or substantially most of irregularly sized compression-freed spaces. Short translations, on the other hand, can restrict data placement and waste space. In an example, a short translation can only store an OS page p at the start of DRAM page d=p % 3 or DRAM page d=(P+1) % 3 where 3 is the total number of DRAM pages. Dashed lines in FIG. 11 indicate placement conflicts for an OS page 3. The computing system 10 can use both short translations and long translations, where short translations are more cache friendly, and long translations can eliminate any wasted space, as discussed above.

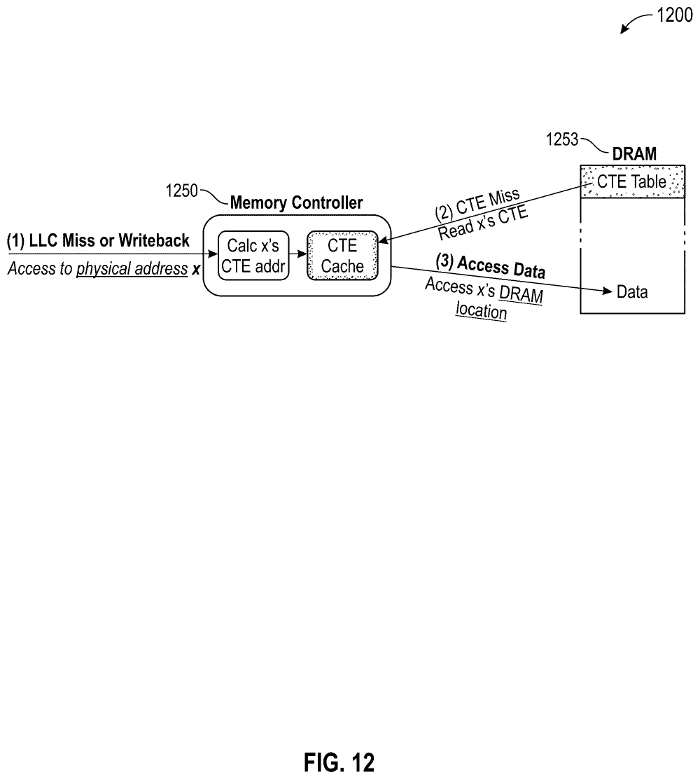

FIG. 12 depicts a block diagram of an interaction between a memory controller and a DRAM for accessing data in one or more computing systems according to various embodiments of the present disclosure. In hardware memory compression, CTEs form an additional address translation layer beyond the conventional virtual memory translation layer. Every memory access can go through one extra layer of indirection that translates a physical address to a DRAM location with the help of a CTE. In block diagram 1200, a memory controller 1250 is in data communion with a DRAM 1253. The memory controller 1250 and the DRAM 1253 can be implemented in the computing system 10. For example, the processing circuit 103 can include the memory controller 1250 and the memory 150 can include the DRAM 1253. The diagram 1200 shows that on an LLC miss, accessing the CTE to determine the location of the requested data increases the critical path of the LLC miss.

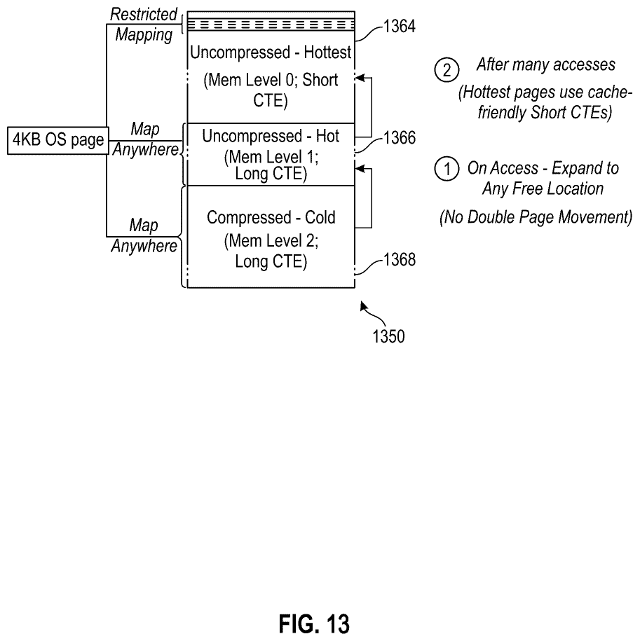

FIG. 13 depicts memory levels or areas of a memory in one or more computing systems according to various embodiments of the present disclosure. For example, a memory 1350 can be implemented in the computing system 10 and includes three memory levels (MLs), where a first ML 1364 (e.g., memory level 0) can be used to store uncompressed pages that are the hottest (e.g., most recently or most frequently accessed), a second ML 1366 (e.g., memory level 1) can be used to store uncompressed pages that are hot (e.g., recently or frequently accessed), and a third ML 1368 (e.g., memory level 0) can be used to store compressed pages that are cold (e.g., not recently or not frequently accessed). To address the bandwidth overhead challenges of the double page movement per page expansion, the computing system 10 can be configured to use both short and long CTEs for uncompressed pages. In particular, the computing system 10 can be configured to access data in the first ML 1364 through cache-friendly short CTEs, access data in the second ML 1366 through long CTEs, and access data in the third ML 1368 through long CTEs. The storage of pages and access or re-access of the pages stored in the MLs 1364, 1366, and 1368 can be executed by the processing circuit 103. It should be noted that the MLs 1364, 1366, and 1368 are depicted as occupying contiguous memory. However, each of the MLs 1364, 1366, and 1368 can be non-contiguous and arbitrarily interleaved.

When first expanding a compressed page to uncompressed form, the computing system 10 uses a long CTE to store the page in any free DRAM page that is currently being tracked by the free list. The computing system 10 can be configured to only selectively switch the hottest uncompressed pages to using short CTEs. Dynamically switching between short and long CTEs for uncompressed pages extends the two-level memory hierarchy into a three-level exclusive hierarchy, as described above.

The first ML 1364 stores uncompressed pages and addresses them using short CTEs. A short CTE of an OS page p can only place p among a small set of possible DRAM pages (e.g., a 2-bit short CTE of p can only place p in one out of 3 possible DRAM pages). This set of DRAM pages can be referred to as p's DRAM page group. The DRAM pages within a DRAM page group are adjacent to each other. Two distinct OS pages can either share the DRAM page group or use distinct DRAM page groups that do not overlap.

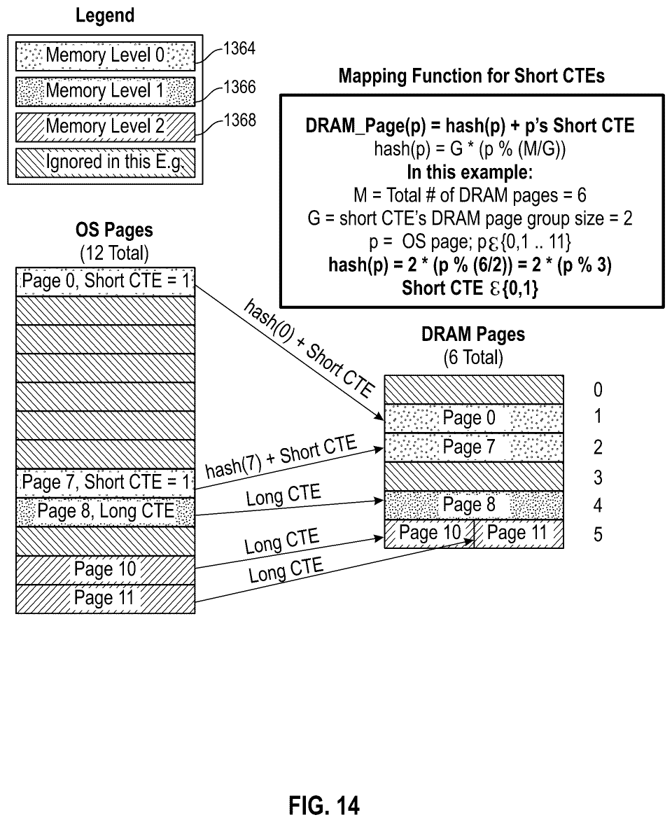

FIG. 14 depicts a mapping of OS tables and DRAM pages in one or more computing systems according to various embodiments of the present disclosure. An example mapping function for short CTEs is shown, where for OS page 7 in the first ML 1364, the OS page 7 is stored at DRAM_page (7)=hash (7)+ShortCTE=2+0=2. Long CTEs are not accompanied by any calculations as each long CTE directly records the current machine-physical address of ML1 or ML2 page. The computing system 10 can be configured to use a static hashing function to identify the first DRAM page in the DRAM page group of an OS page p. The hash function hash (p) takes as input p's page ID, the total number of DRAM pages in the system (M), and the number of DRAM pages per DRAM page group (G). The full hash function is shown in FIG. 14 as hash (p). The multiplication by G ensures two adjacent OS pages map to two distinct DRAM page groups.

The short CTE of page p then specifies which one out of the G DRAM pages in the DRAM group is currently storing p. Therefore, the complete mapping function used by short CTEs is DRAM_Page(p)=hash(p)+p's short CTE. FIG. 14 further shows how to use short CTEs to locate ML0 pages in an example system with 12 OS pages and 6 DRAM pages.

The first ML 1364 is dynamic in size and may scale up to the entire memory system when everything is uncompressed (e.g., when the memory pressure is low). This is because the output range of the hashing function for short CTEs is the entire DRAM. For example, hash (p)=G*(p % (M/G)) approximately simplifies to p % M, where M is the entire DRAM size. As such, any DRAM page can be part of the first ML 1364. In other words, any DRAM page can store an uncompressed page that is currently using a short CTE.

The second ML 1366 can also store uncompressed pages. However, unlike the first ML 1364, pages of the third ML 1368 uses long CTEs so that they can be stored anywhere in memory (e.g., the memory 150). Long CTEs can be 8B each in some examples so that they can encode arbitrary DRAM addresses. The third ML 1368 stores compressed pages and uses long CTEs to address them.

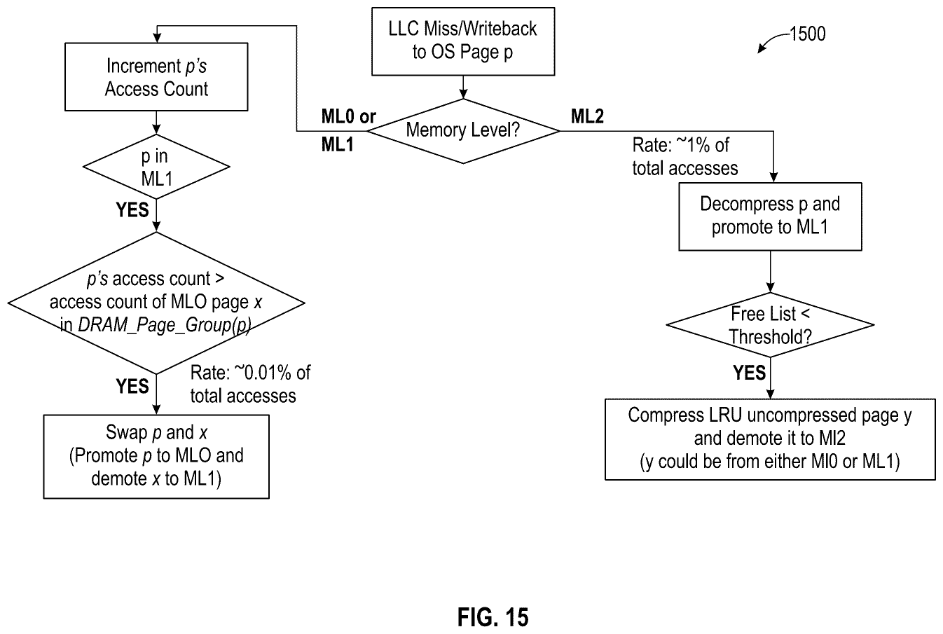

FIG. 15 depicts a flowchart for page management in a three-level memory hierarchy for one or more computing systems according to various embodiments of the present disclosure. Flowchart 1500 can be implemented in the computing system 10, for example. The flowchart 1500 outlines promotion and demotion policies between the MLs 1364, 1366, and 1368. For promotion from the third ML 1368 to the second ML 1366, a promotion policy is the conventional promotion policy used in CPU caches: expand a page from ML2 directly to ML0 similar to how the CPU promotes a cacheline from the L3 cache directly to the L1 cache. However, such a policy continues to incur double page movement per page expansion. Heuristically, a recently expanded page is unlikely to be very hot because it was compressed initially because it was cold and may receive very few accesses before it is compressed again. Experiments confirmed this for various irregular workloads and further confirmed that on average across all benchmarks, a decompressed page receives 16 accesses before it is compressed. Thus, the computing system 10 is configured to execute a gradual promotion policy that first expands a compressed page in the third ML 1368 to the second ML 1366, and then selectively promotes pages in the second ML 1366 to the first ML 1364.

For promotion from the second ML 1366 to the first ML 1364 which triggers a long CTE to a short CTE switch, the computing system 10 selectively promotes the most frequently accessed pages from the second ML 1366 to the first ML 1364. It should be noted that selecting the hottest pages to place into a limited set of page-sized locations can be implemented with various promotion algorithms associated with page-level DRAM caching by maintaining a probabilistic access counter for every OS page. A 5% sampling rate can be relied upon in some cases. Hot pages in the second ML 1366 to promote are identified as ones with access counts that are higher by a threshold than other pages in the second ML 1366 that map to the same DRAM page group. When the computing system 10 promotes a hot page p in the second ML 1366, some of the DRAM pages in p's DRAM page group may contain pages from the second ML 1366 or the third ML 1368 to migrate them elsewhere to free up a DRAM page to store the page p, resulting in page p being stored in the first ML 1364.

A demotion from the first ML 1364 to the MLs 1366 or 1368 can trigger a short CTE to a long CTE switch. When the computing system 10 promotes a page p, if all of the DRAM pages in p's DRAM page group currently contain pages in the first ML 1364, the computing system 10 can be configured to demote one of these pages in the first ML 1364 to the second ML 1366 (i.e., switching corresponding short CTE to long CTE to migrate it to a free DRAM page tracked by the free list in the corresponding ML). The computing system 10 compares the access counters of these pages in the first ML 1364 to select the coldest page in the first ML 1364 to demote. In one example, if the compression using the recency list selects a page from the first ML1364 as a victim, the page is compressed and demoted to the third ML 1368, which can trigger a switch from short CTE to a long CTE.

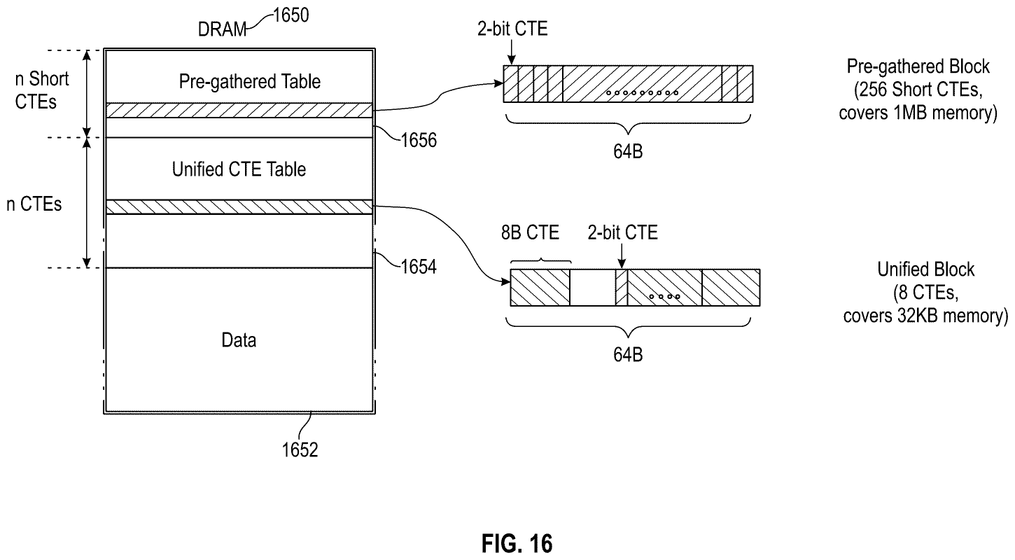

FIG. 16 depicts various CTE tables that can be stored in a DRAM for one or more computing systems according to various embodiments of the present disclosure. For example, the memory 150 in the computing system 10 can include a DRAM 1650, and the DRAM 1650 can include a pre-gathered table 1656 for storing short CTE, a unified CTE table 1654 for storing short and/or long CTEs, and a data area 1652 for storing other DRAM data. To minimize waste in the CTE cache in the processing circuit 103, the computing system 10 is configured to gather copies of short CTEs densely together into the pre-gathered table 1656 that is optimized for short CTEs. Each 64B block in the pre-gathered table 1656 densely packs 64B/2 bits=256 short CTEs back-to-back, without wasting any space. As such, each block can provide a translation reach of 256*4 KB=1 MB according to one example, which similar to a huge page. Unlike naïve short CTE cache designs that gather the short CTEs from a unified CTE block into a short CTE cacheline after fetching the CTE block on a CTE miss, the computing system 10 proactively gathers/copies the short CTE of a page from the unified CTE table 1654 to the pre-gathered table 1656 when promoting the page to the first ML 1364.

The internal organization of the pre-gathered table 1656 and the internal organization of the unified CTE table 1654 is shown in FIG. 16. In one example, the pre-gathered table 1656 is statically sized to contain a 2-bit entry for every 4 KB OS page in the computing system 10. For OS pages that use long CTEs (i.e., OS pages in the second or third MLs 1366 or 1368), the short CTE in the pre-gathered table 1656 records an invalid flag value. The flag value is the maximum encodable number (e.g., “3” for a 2-bit short CTE). As such, 2-bit short CTEs may only support three DRAM pages per DRAM page group. The computing system 10 is configured to update the short CTE in the pre-gathered table 1656 whenever the unified CTE table 1654 is updated (i.e., when the computing system 10 promotes/demotes a page between the memory levels 1364-1368).

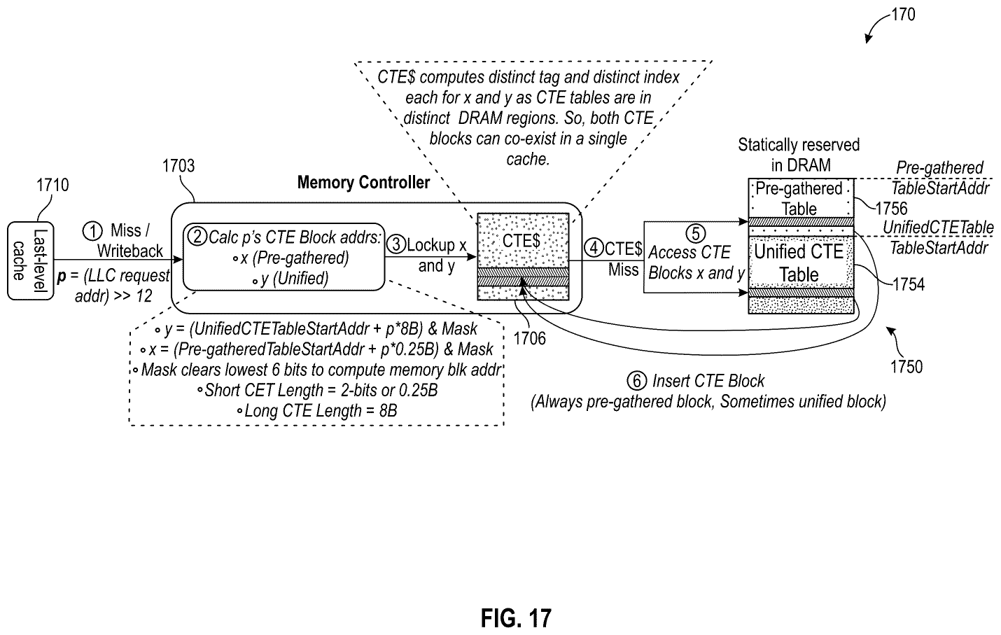

FIG. 17 depicts a block diagram of an example computing system for dynamically managing storage of data in memory based on short and long CTEs according to various embodiments of the present disclosure. Computing system 170 includes an MC 1703, a DRAM 1750, and an LLC 1710. In various examples, the computing system 170 can be used in conjunction with the computing system 10 to dynamically manage storage and access of data in memory based on short and long CTEs. To maximize CTE cache hit rate and store as many short CTEs as possible, the computing system 170 includes a single CTE cache 1706 in the MC 1703 that can store both pre-gathered and unified CTE blocks in corresponding pre-gathered CTE table 1756 and unified CTE table 1754. A single CTE cache inherently allows dynamic partitioning as per workload execution. Unlike the TLB, which is physically split across different dedicated TLBs for 2 MB and 4 KB PTEs to provide high bandwidth as TLBs are accessed for every instruction, a unified CTE cache such as the CTE cache 1706 is feasible at the MC level, where the access rate is much lower.

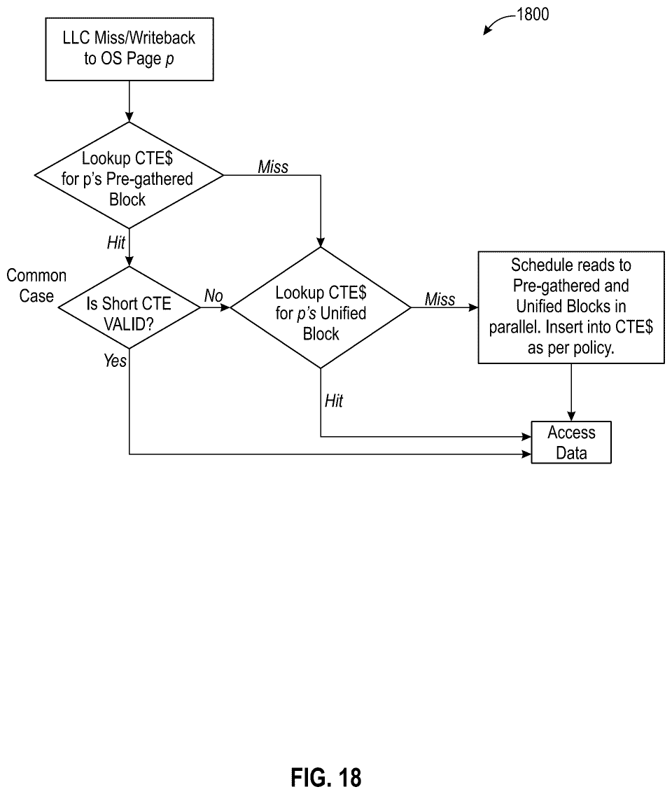

FIG. 18 depicts a flowchart that can be executed by one or more computing systems for managing data access in memory according to various embodiments of the present disclosure. The computing system 170 can be configured to implement flowchart 1800 for example. As the CTE cache 1706 can store blocks from two distinct CTE tables 1754 and 1756, the behavior of the computing system 170 can deviate between CTE cache hits and misses. A CTE cache hit can be defined as when a memory access can be fulfilled by a cached CTE block regardless of whether the block is a pre-gathered block or a unified block. In one example, for a memory access to page p, the computing system 170 first calculates the address of p's pre-gathered block and then looks up the CTE cache 1706 for the pre-gathered block. If the pre-gathered block hits in the cache 1706, the computing system 170 can check whether the short CTE is valid. If it is, the computing system 170 can use the hashing function and short CTE to compute the DRAM page address of the requested data. Otherwise, the computing system 170 can look for a unified block in the cache 1706. If there is a hit, the computing system 170 can use the long CTE to access data. In the flowchart 1800, a common case is triggered when the short CTE is valid (e.g., OS Page p is in the first ML 1364). In contrast, an uncommon case is triggered when the short CTE is not valid or there is a CTE miss in a pre-gathered block in the CTE cache 1706.

A CTE cache miss can be defined as when the DRAM address for a memory request cannot be determined by the CTE cache 1706. As such, for a request to a page in the first ML 1364, a cache miss can occur when both the pre-gathered block and the unified block are missing. For a request to pages in the second ML 1366 or the third ML 1368, however, a cache miss can occur when the unified block misses in the cache 1706. At the time of each CTE miss, the computing system 170 does not know which memory level the requested page belongs to. A naïve option is to first assume the page is in the first ML 1364 and if the assumption is wrong, then sequentially fetch the unified block. However, this approach can double the CTE access time. Thus, the computing system 170 fetches both blocks in parallel which can preserve low CTE cache miss latencies. In implementations, the aggregate bandwidth overhead due to CTE cache misses is small because the computing system 170 significantly reduces overall CTE cache miss rate.

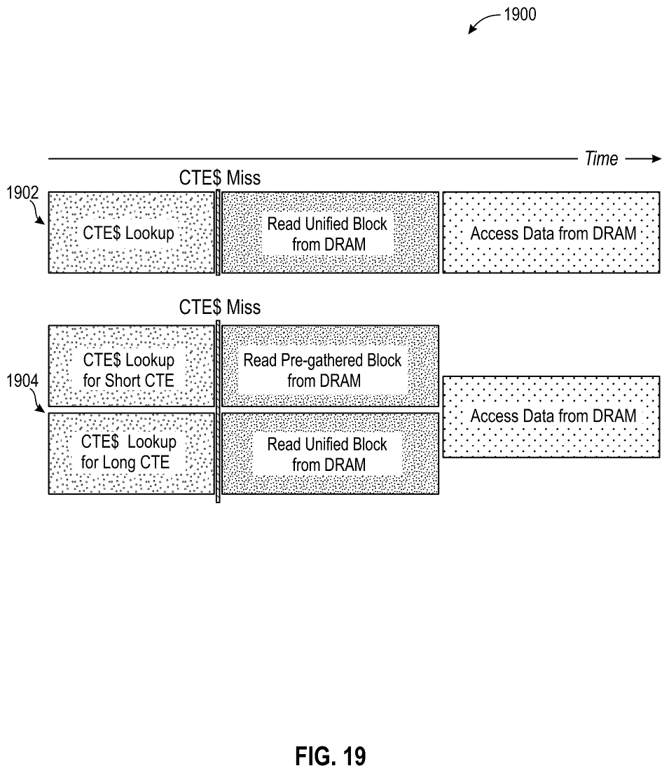

FIG. 19 depicts an example timing diagram comparing a timeline of a CTE cache miss in one or more computing systems versus previous approaches according to various embodiments of the present disclosure. Compared to a previous approach outlined by sequence 1902, the computing system 170 is configured to implement sequence 1904 which includes fetching both CTE blocks in parallel to avoid increasing the latency of CTE misses. If the memory request is to a page in the first ML 1364, as soon as either one of the two CTE block arrives, the ensuing data access can begin. Otherwise, the ensuing data access begins after the unified block arrives. As the computing system 170 can be configured to fetch both CTE blocks per CTE miss, the computing system 170 can selectively cache one of the two blocks or cache both. The computing system 170 can be configured to always cache the pre-gathered block, which provides high translation reach. The computing system 170 can be configured to cache the unified block only if the memory request suffering from the CTE miss is to a page in the second ML 1366 or to a page in the third ML 1368.

The concepts described herein can be combined in one or more embodiments in any suitable manner, and the features discussed in the embodiments are interchangeable in some cases. Example embodiments are described herein, although a person of skill in the art will appreciate that the technical solutions and concepts can be practiced in some cases without all of the specific details of each example. Additionally, substitute or equivalent steps, components, materials, and the like may be employed.

The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Terms such as “a,” “an,” “the,” and “said” are used to indicate the presence of one or more elements and components. The terms “comprise,” “include,” “have,” “contain,” and their variants are used to be open ended and may include or encompass additional elements, components, etc., in addition to the listed elements, components, etc., unless otherwise specified. The terms “first,” “second,” etc. may be used as differentiating identifiers of individual or respective components among a group thereof, rather than as a descriptor of a number of the components, unless clearly indicated otherwise.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or metric of deviation, account for at least some manufacturing tolerances between a theoretical design and a manufactured product or assembly. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

Therefore, at least the following is claimed:

1. A computing system, comprising:
a memory comprising a plurality of memory levels; and
a processing circuit configured to dynamically manage storage of data in the memory based on instructions received from an operating system (OS), wherein to dynamically manage storage of the data, the processing circuit is further configured to:
determine a first memory level and a second memory level among the plurality of memory levels, the first memory level being used to store uncompressed pages and the second memory level being used to store compressed pages;
determine a free list of free pages in the first memory level or the second memory level; and
store a page associated with the data in the first level or the second level based at least in part on the free list.

2. The computing system of claim 1, wherein the processing circuit is further configured to store the page associated with the data in the first memory level or the second memory level based further on a number of pages stored in the first memory level, a number of pages stored in the second memory level, or a number of pages stored in the first memory level and in the second memory level.

3. The computing system of claim 1, wherein to dynamically manage storage of the data, the processing circuit is further configured to compress a page table block (PTB) associated with the page, the PTB being compressed by embedding a compression translation entry (CTE) to the PTB, thereby causing the OS to prefetch the CTE during a page walk instead of serially fetching the CTE after a page walk.

4. The computing system of claim 3, wherein:
the CTE comprises a bit vector of bits; and
each bit tracks whether one or more adjacent blocks for the page are using an encoding associated with the compressed PTB.

5. The computing system of claim 3, wherein:
the CTE is stored in a CTE table in the memory; and
the CTE table comprises a flat table where each CTE stored in the CTE table corresponds to a page associated with the data.

6. The computing system of claim 3, wherein the CTE is 8 bytes long, the PTB is a 64-byte memory block, and the PTB block configurable to store 8 CTEs.

7. The computing system of claim 1, wherein:
the page is stored as a compressed page in the second memory level; and
the processing circuit is further configured to decompress the compressed page into an uncompressed page and move the uncompressed page to a free page in the first memory level in response to an access of the page.

8. The computing system of claim 7, wherein a location of the free page is determined based on the free list.

9. The computing system of claim 7, wherein the access is associated with a last-level cache (LLC) miss or a translation lookaside buffer (TLB) miss.

10. The computing system of claim 7, wherein the processing circuit is further configured to update the CTE associated with the page after the page is moved to the first memory level and upon a subsequent access of the uncompressed page by a page walker.

11. The computing system of claim 7, wherein the processing circuit is further configured to compress the uncompressed page to a compressed page and move the compressed page to a free page in the second memory level based on a recency list that tracks a plurality of compressed or uncompressed pages in the memory.

12. The computing system of claim 11, wherein to dynamically manage storage of the data, the processing circuit is further configured to:
maintain at least 16 MB of free memory pages in the free list; and
compress one or more pages that are least frequently or least recently accessed according to the recency list if the free memory pages in the free list drops below 16 MB.

13. The computing system of claim 1, wherein:
the free list in the first memory level comprises 4 KB chunks; and
the free list in the second memory level comprises 4 KB chunks and smaller sub-chunks within the 4 KB chunks.

14. The computing system of claim 1, wherein:
the processing circuit is a memory controller; and
the memory is a dynamic random-access memory (DRAM) separate from the memory controller.

15. A computing system, comprising:
a memory comprising a plurality of memory levels;
a processing circuit configured to dynamically manage storage of data in the memory based on instructions received from an operating system (OS), wherein to dynamically manage storage of the data, the processing circuit is further configured to:
determine at least two memory levels among the plurality of memory levels to store uncompressed pages and a third memory level among the plurality of memory levels to store compressed pages;
dynamically determine a free list of free pages in each of the at least two memory levels and the third memory level in real-time; and
store a page associated with the data in the at least two memory levels or the third memory level based at least in part on the free list.

16. The computing system of claim 15, wherein:
a first memory level of the at least two memory levels is configured to store one or more uncompressed pages that are most frequently or most recently accessed according to a recency list that tracks a plurality of uncompressed pages or compressed pages in the memory;
a second memory level of the at least two memory levels is configured to store one or more uncompressed pages that are frequently or recently accessed according to the recency list; and
the third memory level is configured to store one or more compressed pages that are least frequently or least recently accessed according to the recency list.

17. The computing system of claim 16, wherein:
one or more uncompressed pages stored in the first memory level are each associated with a compressed translation entry (CTE) of a first length;
one or more uncompressed pages stored in the second memory level are each associated with a CTE of a second length, the second length being longer from the first length; and
one or more compressed pages stored in the third memory level are each associated with a CTE of the second length.

18. The computing system of claim 17, wherein:
the first length is 2 bits; and
the second length is 8 bits.

19. The computing system of claim 17, wherein the processing circuit is configured to store CTEs of the first length in a separate table from a table that stores CTEs of the second length.

20. The computing system of claim 17, wherein the processing circuit is configured to store the page associated with the data in the first memory level, the second memory level, or the third memory level based on a number of pages stored in the first memory level, a number of pages stored in the second memory level, and/or a number of pages stored in the third memory level.
